(19) United States
(12) Patent Application Publication
(10) Pub. No.: US 2025/0353102 A1
(43) Pub. Date: Nov. 20, 2025

(54) Electrode Tab Welding Device, Electrode Tab Welding Method, and Electrode Assembly

(71) Applicant: LG Energy Solution, Ltd., Seoul (KR)

(72) Inventors: Won Nyeon Kim, Daejeon (KR); Hyun Tae Kim, Daejeon (KR); In Kook Jun, Daejeon (KR); Han Joo Jo, Daejeon (KR); Jae Beom Jeon, Daejeon (KR)

(73) Assignee: LG Energy Solution, Ltd., Seoul (KR)

(21) Appl. No.: 18/721,548

(22) PCT Filed: Dec. 23, 2022
(86) PCT No.: PCT/KR2022/021189

§ 371 Date: Jun. 18, 2024

(30) Foreign Application Priority Data
Dec. 23, 2021 (KR) 10-2021-0186535

(51) Int. Cl. B23K 11/06; H01M 50/46; H01M 50/536; H01M 50/538; H01M 50/54

(52) U.S. Cl. CPC B23K 11/061; H01M 50/46; H01M 50/536; H01M 50/538; H01M 50/54

(57) ABSTRACT

An electrode tab welding device according to an embodiment of the present invention may weld a plurality of electrode tabs of an electrode assembly. The electrode tab welding device may include: a pair of tab guides that gather the plurality of electrode tabs; a pair of aligning rollers that rotate in a direction, in which the outermost electrode tab is pushed toward the electrode assembly, while pressing the plurality of electrode tabs gathered by the pair of tab guides; and a welding part that welds the plurality of electrode tabs, which are aligned by the pair of aligning rollers, to each other.

### CROSS-REFERENCE TO RELATED APPLICATION

The present application is a national phase entry under 35 U.S.C. § 371 of PCT/KR2022/021189 filed Dec. 23, 2022, which claims the benefit of the priority of Korean Patent Application No. 10-2021-0186535, filed on Dec. 23, 2021, which is hereby incorporated by reference in its entirety.

### TECHNICAL FIELD

The present invention relates to an electrode tab welding device, which welds a plurality of electrode tabs to each other, an electrode tab welding method, and an electrode assembly including the plurality of electrode tabs welded by the electrode tab welding device or electrode tab welding method.

### BACKGROUND ART

In general, secondary batteries refer to batteries, which are chargeable and dischargeable unlike non-rechargeable primary batteries, and are widely used in electronic devices such as mobile phones, notebook computers and camcorders, electric vehicles, or the like. In particular, lithium secondary batteries have a larger capacity and a higher energy density than nickel-cadmium batteries or nickel-hydrogen batteries, and thus utilization thereof is on a rapidly increasing trend.

According to the shape of a battery case, the secondary batteries may be classified into a cylindrical type battery and a prismatic type battery, each of which has an electrode assembly embedded in a cylindrical or prismatic metal can, a pouch type battery having an electrode assembly embedded in a pouch type case made of an aluminum laminate sheet, and so on.

FIG. 1 is a view illustrating an example of a pouch type secondary battery. A pouch type secondary battery 1 includes an electrode assembly 10, in which an electrode and a separator are provided to be alternately stacked, and a pouch 20 in which the electrode assembly 10 is accommodated. Each of electrode tabs 15 may be connected to the electrode of the electrode assembly 10. The electrode tabs 15 may be welded to each other in a predetermined region and then connected to an electrode lead 17. The pouch 20 includes a cup part 21 having a recessed shape for accommodating the electrode assembly 10. The cup part 21 of the pouch 20 may be provided in one or two. FIG. 1 illustrates the pouch 20 including a left cup part and a right cup part. A circumferential part 23 (terrace) is formed around a circumference of the cup part 21 by sealing.

However, the electrode tab 15 may be gradually tightened and disconnected when a pulling force is applied to the electrode tab 15 due to deformation of the circumferential part 23 of the pouch 20. In addition, the electrode tab 15 may be gradually tightened and disconnected also when the pulling force is applied to the electrode tab 15 due to swelling of the pouch 20. Such disconnection is cited as a leading cause of an occurrence of a fire. Recently, the pouch type secondary battery is reduced in length of the circumferential part 23 in order to increase energy density according to a demand for a large capacity and high performance. However, this leads to a decrease of the “length of the electrode tab 15, from the electrode assembly 10 to a welding point of the electrode tabs 15”, and thus a risk of the disconnection is further increased.

### DISCLOSURE OF THE INVENTION

### Technical Problem

An object of the present invention for solving the above problems is to provide an electrode tab welding device and an electrode tab welding method, which prevent disconnection of an electrode tab.

Another object of the present invention for solving the above problems is to provide an electrode assembly in which disconnection of an electrode tab is prevented.

### Technical Solution

An electrode tab welding device according to an embodiment of the present invention may weld a plurality of electrode tabs of an electrode assembly to each other. The electrode tab welding device may include: a pair of tab guides that gather the plurality of electrode tabs; a pair of aligning rollers that rotate in a direction, in which the outermost electrode tab is pushed toward the electrode assembly, while pressing the plurality of electrode tabs gathered by the pair of tab guides; and a welding part that welds the plurality of electrode tabs, which are aligned by the pair of aligning rollers, to each other.

A point at which the pair of aligning rollers press the plurality of electrode tabs may be farther away from the electrode assembly than a point at which the pair of tab guides press the plurality of electrode tabs is.

When the pair of tab guides have a first gap therebetween, the pair of aligning rollers may rotate in a state of pressing the plurality of electrode tabs, and when the pair of tab guides have a second gap smaller than the first gap therebetween, the pair of aligning rollers may be spaced apart from the plurality of electrode tabs.

When the pair of tab guides have the second gap therebetween, the welding part may weld the plurality of electrode tabs to each other.

Each of the pair of aligning rollers may include an elastomer material.

The pair of aligning rollers may be disposed to face each other with the plurality of electrode tabs therebetween in a height direction of the electrode assembly, and be configured so that a distance therebetween can be adjusted.

An electrode tab welding method according to an embodiment of the present invention may weld a plurality of electrode tabs of an electrode assembly to each other. The electrode tab welding method may include: allowing a pair of tab guides to approach each other so as to gather the plurality of electrode tabs; allowing a pair of aligning rollers to rotate in a state of pressing the plurality of electrode tabs gathered by the pair of tab guides so as to push the outermost electrode tab of the plurality of electrode tabs toward the electrode assembly; and welding the plurality of electrode tabs, which are aligned by the pair of aligning rollers, to each other by a welding part.

When the pair of aligning rollers rotate, the pair of tab guides may have a first gap therebetween, and when the welding part welds the plurality of electrode tabs to each other, the pair of tab guides may have a second gap smaller than the first gap from therebetween.

When the pair of aligning rollers rotate, a stepped portion may occur between outer ends of the plurality of electrode tabs.

When the welding part welds the plurality of electrode tabs, the pair of aligning rollers may be spaced apart from the plurality of electrode tabs.

An electrode assembly according to an embodiment of the present invention may include a plurality of electrodes stacked with a separator therebetween, and a plurality of electrode tabs which are connected to the plurality of electrodes, respectively, and welded to each other so as to form a welded portion. Both the outermost electrode tabs of the plurality of electrode tabs may be convexly bent outward. Each of the outermost electrode tabs may include a first section extending from the electrode, and a second section extending from the first section and having a steeper slope than the first section. The first section may include a flat portion, which is connected to the electrode and provided to be flat, and a bending portion which connects the flat portion and the second section to each other and is provided to be bent.

In the plurality of electrode tabs, the more outward the electrode tab is disposed, the more bent the electrode tab may be.

The outermost electrode tab may have an outer end that is stepped inward from outer ends of other electrode tabs.

The outermost electrode tab may further include a third section extending from the second section to the welded portion and having a gentler slope than the second section.

### Advantageous Effects

According to the preferred embodiments of the present invention, the welding part may weld the plurality of electrode tabs to each other in the state in which the plurality of electrode tabs are pushed toward the electrode assembly by the aligning rollers, and thus, each of the electrode tabs, particularly the outermost electrode tab, may have the increased length from the electrode to the welded portion. Accordingly, the electrode tab, particularly the outermost electrode tab, may be prevented from being broken and disconnected by the external force due to the deformation such as the bending of the electrode lead, and the safety and the reliability of the electrode assembly may be improved.

In addition, the effects may be included which could be easily predicted by those skilled in the art from the configurations according to the preferred embodiments of the present invention.

### BRIEF DESCRIPTION OF THE DRAWINGS

The following drawings attached in this specification illustrate a preferred embodiment of the present invention and function to make further understood the technical spirit of the present invention along with the detailed description of the invention. The present invention should not be construed as being limited to only the drawings.

FIG. 1 is a view illustrating an example of a pouch type secondary battery.

FIGS. 2a to 2d are views for explaining one example of a process applicable to welding of electrode tabs of a pouch type secondary battery.

FIG. 3 is a cross-sectional view illustrating a portion of a battery module provided with several pouch type batteries accommodated in a pouch.

FIGS. 4 to 6 are views for explaining a configuration and an operation of an electrode tab welding device according to an embodiment of the present invention.

FIG. 7 is a flowchart of an electrode tab welding method according to another embodiment of the present invention.

FIG. 8 is view illustrating an electrode assembly according to further another embodiment of the present invention.

### MODE FOR CARRYING OUT THE INVENTION

Hereinafter, preferred embodiments of the present invention will be described in detail with reference to the accompanying drawings to enable those skilled in the art to which the present invention pertains to easily carry out the present invention. The present invention may, however, be embodied in different forms and should not be construed as limited by the embodiments set forth herein.

The parts unrelated to the description, or the detailed descriptions of related well-known art that may unnecessarily obscure subject matters of the present invention, will be ruled out in order to clearly describe the present invention. Like reference numerals refer to like elements throughout the whole specification.

Moreover, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe his or her invention in the best ways.

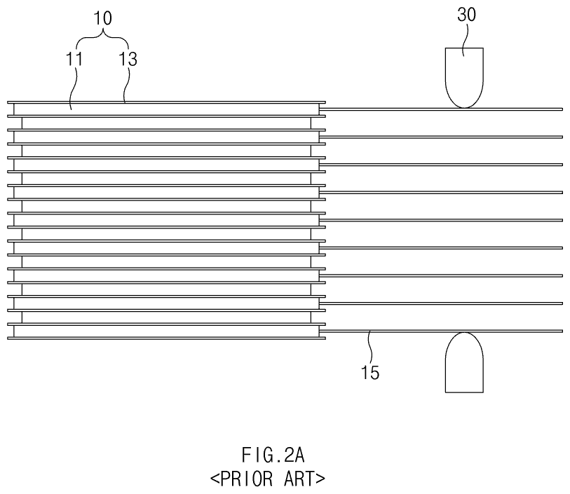

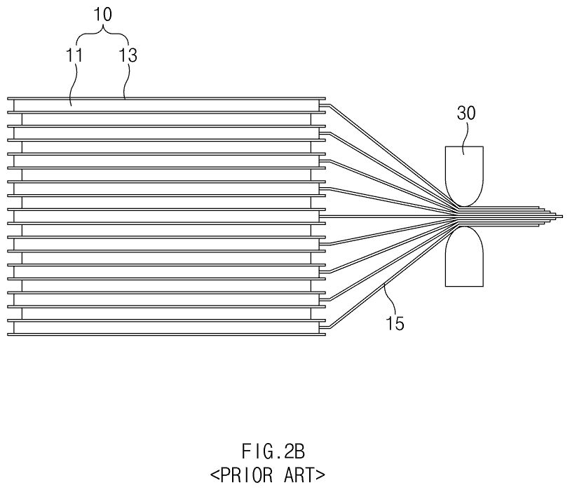

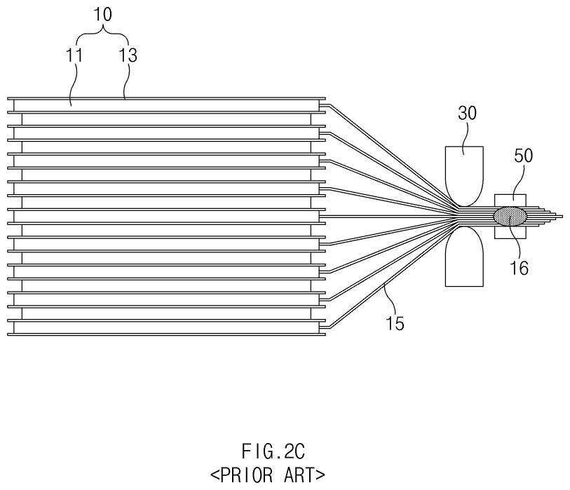

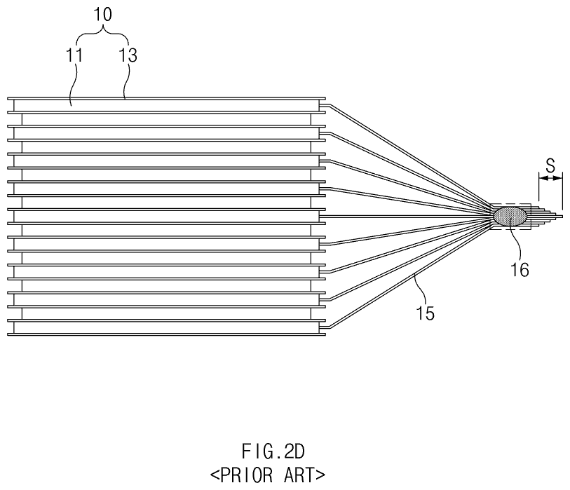

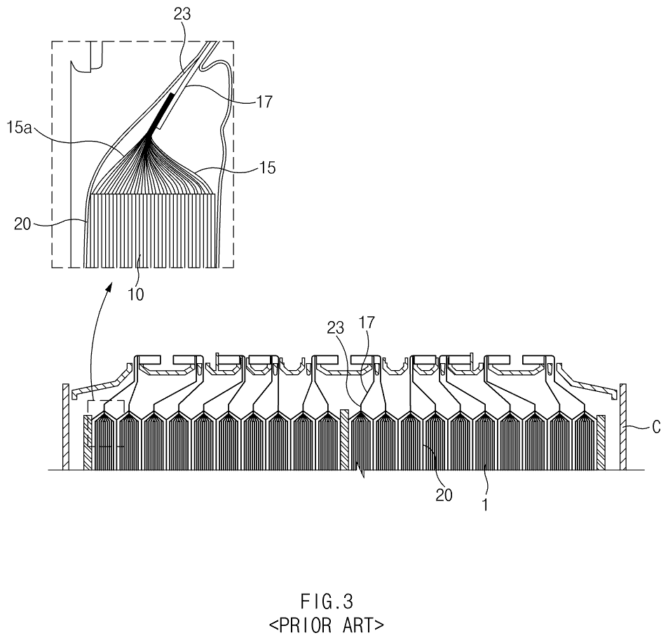

FIGS. 2a to 2d are views for explaining one example of a process applicable to welding of electrode tabs of a pouch type secondary battery. FIG. 3 is a cross-sectional view illustrating a portion of a battery module provided with several pouch type batteries accommodated in a pouch.

First, as in FIG. 2a, an electrode assembly 10 may be prepared in which a plurality of electrodes 11 and a plurality of separators 13 are alternately stacked. The plurality of electrodes 11 may include a positive electrode and a negative electrode, and an electrode tab 15 may be connected to each of the electrodes 11. Although the drawings illustrate only a negative electrode tab connected to the negative electrode for convenience of explanation, it could be easily understood by those skilled in the art that a positive electrode tab connected to the positive electrode may be also provided in the electrode assembly 10 and welded in the same manner as the negative electrode tab.

Next, as in FIG. 2b, a pair of tab guides 30 may press the plurality of electrode tabs 15 so as to gather the plurality of electrode tabs 15. The pair of tab guides 30 may face each other with the plurality of electrode tabs 15 therebetween in a height direction of the electrode assembly 10, and a distance therebetween may be adjusted.

Then, as in FIG. 2c, the plurality of electrode tabs 15 may be welded to each other through a welding part 50. In more detail, the welding part 50 may weld the plurality of electrode tabs 15 to each other and form a welded portion 16. The welded portion 16 formed in the plurality of electrode tabs 15 may be farther away from the electrode assembly 10 than a point at which the plurality of electrode tabs 15 are pressed by the pair of tab guides 30 is.

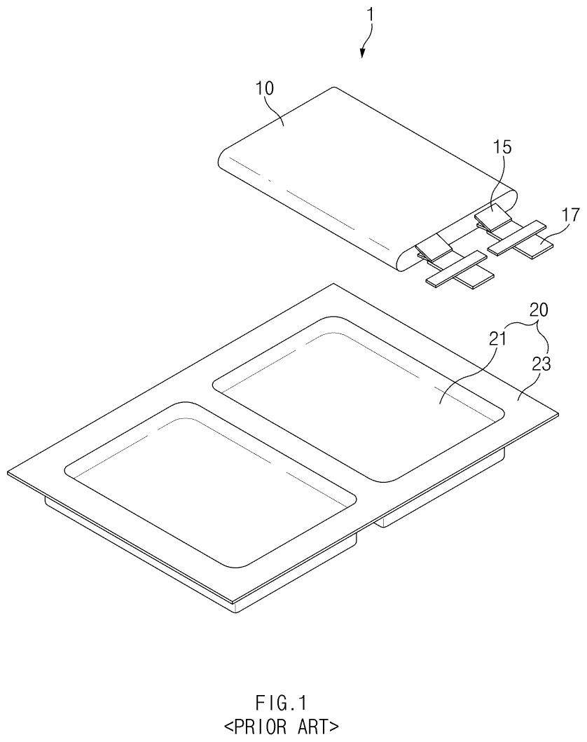

The electrode assembly 10 including the plurality of electrode tabs 15 welded to each other in the welded portion 16 may be manufactured through those processes. A pouch type battery 1 may be manufactured by connecting the electrode lead 17 (see FIG. 1) to the plurality of electrode tabs 15 welded to each other and then, accommodating the electrode assembly 10 in the pouch 20 (see FIG. 1).

As illustrated in FIG. 3, a plurality of pouch type batteries 1 may be accommodated in a case C and manufactured as a battery module. However, a circumferential part 23 of the pouch 20 may be bent during the manufacture of the battery module. The deformation of the circumferential part 23 may cause bending of the electrode lead 17 and thus, a pulling force may be applied to the electrode tab 15 connected to the electrode lead 17. This force may pull the electrode tab 15 tightly to cause disconnection of the electrode tab 15, and the outermost electrode tab 15a may be more affected. The problem of the disconnection as above may be also caused by swelling of the pouch type battery 1.

The present invention to be described in detail below is intended to solve the problem of the disconnection as above.

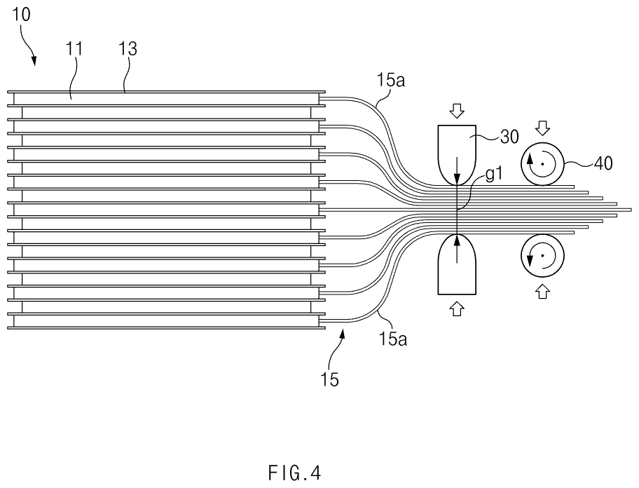

FIGS. 4 to 6 are views for explaining a configuration and an operation of an electrode tab welding device according to an embodiment of the present invention.

The electrode tab welding device according to an embodiment of the present invention may weld a plurality of electrode tabs 15 of an electrode assembly 10 to each other. In more detail, the electrode tab welding device may include a pair of tab guides 30 that gather a plurality of electrode tabs 15, a pair of aligning rollers 40 that rotate in a direction, in which the electrode tabs 15 are pushed toward the electrode assembly 10, while pressing the electrode tabs 15 gathered by the pair of tab guides 30, and a welding part 50 that welds the plurality of electrode tabs 15, which are aligned by the pair of aligning rollers 40, to each other.

The pair of tab guides 30 may face each other with the plurality of electrode tabs 15 therebetween in a height direction of the electrode assembly 10. The pair of tab guides 30 may be configured so that a distance therebetween can be adjusted. In more detail, at least one of the pair of tab guides 30 may be configured to be movable up and down in the height direction of the electrode assembly 10.

As illustrated in FIG. 4, the pair of tab guides 30 may approach each other so as to gather the plurality of electrode tabs 15. During this process, the pair of tab guides 30 may be in contact with a pair of the outermost electrode tabs 15a, respectively, among the plurality of electrode tabs 15.

The smaller a gap between the pair of tab guides 30 is, the more strongly the pair of tab guides 30 may press the plurality of electrode tabs 15.

The pair of aligning rollers 40 may face each other with the plurality of electrode tabs 15 therebetween in the height direction of the electrode assembly 10. The pair of aligning rollers 40 may be configured so that a distance therebetween can be adjusted. In more detail, at least one of the pair of aligning rollers 40 may be configured to be movable up and down in the height direction of the electrode assembly 10.

As illustrated in FIG. 4, the pair of aligning rollers 40 may rotate in a state of pressing the plurality of electrode tabs 15 gathered by the pair of tab guides 30. In more detail, the pair of aligning rollers 40 may be in contact with the pair of the outermost electrode tabs 15a, respectively, and may rotate in a direction in which the outermost electrode tabs 15a are pushed toward the electrode assembly 10.

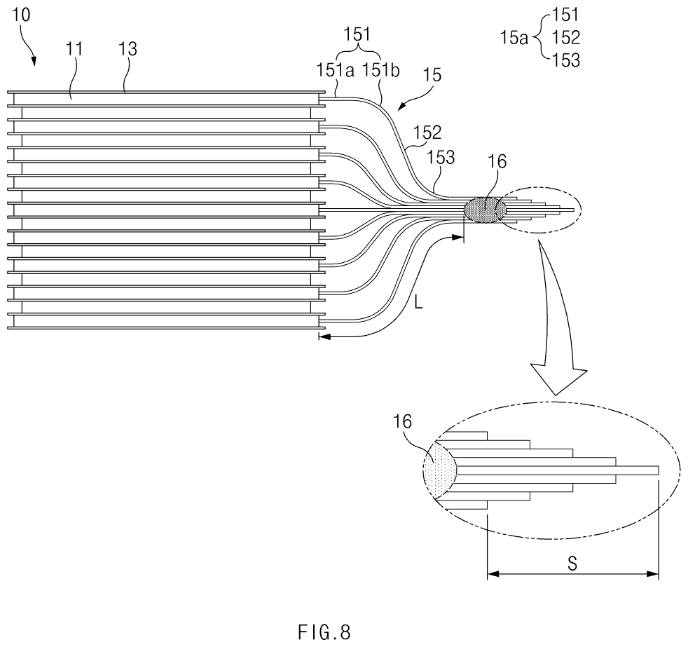

The plurality of electrode tabs 15 may be pushed toward the electrode assembly 10 by a frictional force therebetween. The more outward the electrode tab 15 is disposed, the more pushed the electrode tab 15 may be toward the electrode assembly 10. Accordingly, a stepped portion S (see FIG. 8) between outer ends of the plurality of electrode tabs 15 may occur. That is, the pair of aligning rollers 40 may align the plurality of electrode tabs 15 so that the stepped portion between the outer ends of the plurality of electrode tabs 15 occur.

Each of the aligning rollers 40 may have a material that has a high surface friction coefficient and is elastic. In more detail, the aligning roller 40 may include an elastomer material such as rubber. Accordingly, as the frictional force between the aligning roller 40 and each of the outermost electrode tabs 15a is maintained to be high, the aligning roller 40 may rotate with respect to the outermost electrode tab 15a without slipping. In addition, the aligning roller 40 may be elastically deformed while pressing the outermost electrode tab 15a and thus, occurrence of damage to the outermost electrode tab 15a may be prevented.

The pair of aligning rollers 40 may be disposed to be farther away from the electrode assembly 10 than the pair of tab guides 30 are. In more detail, a point at which the pair of aligning rollers 40 press the plurality of electrode tabs 15 may be farther away from the electrode assembly 10 than a point at which the pair of tab guides 30 press the plurality of electrode tabs 15 is.

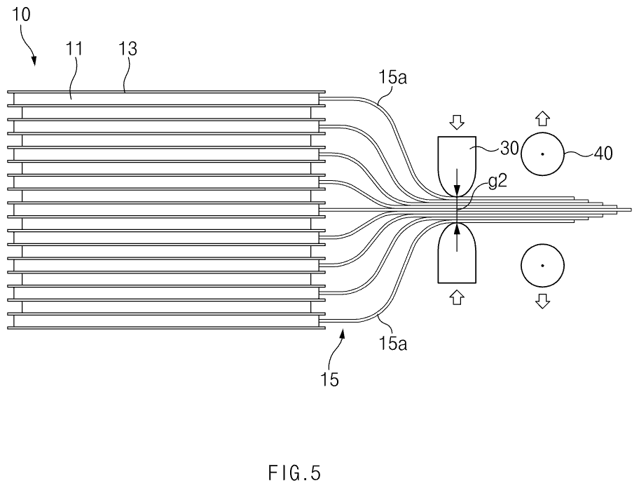

As illustrated in FIG. 5, the pair of tab guides 30 may more strongly press and fix the plurality of electrode tabs 15 after the plurality of electrode tabs 15 are aligned.

In more detail, when the pair of tab guides 30 have a first gap g1 therebetween, the pair of aligning rollers 40 may rotate in a state of pressing the plurality of electrode tabs 15, and when the pair of tab guides 30 have a second gap g2 smaller than the first gap g1 therebetween, the pair of aligning rollers 40 may be spaced apart from the plurality of electrode tabs 15.

When the pair of tab guides 30 have the first gap g1 therebetween, the pair of aligning rollers 40 may align the plurality of electrode tabs 15. When the aligning of the plurality of electrode tabs 15 is completed, the pair of tab guides 30 may approach each other and have the second gap g2 smaller than the first gap g1 therebetween.

When the pair of tab guides 30 have the first gap g1 therebetween, the plurality of electrode tabs 15 may be movable in the longitudinal direction without being completely fixed between the pair of tab guides 30. Thus, when the pair of aligning rollers 40 rotate, the plurality of electrode tabs 15 may be pushed inward between the pair of tab guides 30.

When the pair of tab guides 30 have the second gap g2 therebetween, the plurality of electrode tabs 15 may be fixed between the pair of tab guides 30. Accordingly, the plurality of electrode tabs 15 may be fixed between the pair of tab guides 30 in the aligned state.

When the plurality of electrode tabs 15 are fixed between the pair of tab guides 30, the pair of aligning rollers 40 may move so as to be away from each other, and be spaced apart from the plurality of electrode tabs 15.

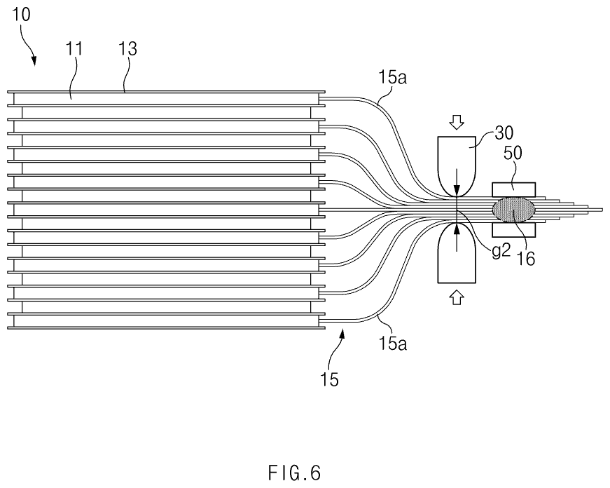

As illustrated in FIG. 6, the welding part 50 may weld the plurality of electrode tabs 15, which are aligned by the pair of aligning rollers 40, to each other so as to form a welded portion 16. The welded portion 16 may be a portion at which the plurality of electrode tabs 15 are welded to each other.

The welding part 50 may perform the welding in a state in which the plurality of electrode tabs 15 are fixed by the pair of tab guides 30. In more detail, the welding part 50 may weld the plurality of electrode tabs 15 to each other when the pair of tab guides 30 have the second gap g2 therebetween.

For example, the welding part 50 may perform ultrasonic welding on the plurality of electrode tabs 15. In this case, the welding part 50 may include an anvil, which is disposed at one side (e.g., a lower side) of the plurality of electrode tabs 15, and a horn which is disposed at the other side (e.g., an upper side) of the plurality of electrode tabs 15. The welding part 50 may be configured so that a distance between the anvil and the horn is adjusted. In a state in which the plurality of electrode tabs 15 are pressed between the anvil and the horn, the horn may undergo the ultrasonic vibration and thus, the plurality of electrode tabs 15 may be welded to each other.

The welding part 50 may be disposed to be farther away from the electrode assembly 10 than the pair of tab guides 30 are. In more detail, the welded portion 16 may be farther away from the electrode assembly 10 than the point at which the pair of tab guides 30 press the plurality of electrode tabs 15 is.

Hereinafter, an operation of the welding device according to this embodiment will be described.

As illustrated in FIG. 4, the pair of tab guides 30 may approach each other and press the outermost electrode tabs 15a so as to gather the plurality of electrode tabs 15. Here, the pair of tab guides 30 may relatively weakly press the plurality of electrode tabs 15 so that the plurality of electrode tabs 15 are not completely fixed.

Next, the pair of aligning rollers 40 may approach each other so as to press the outermost electrode tabs 15a, and may rotate so that the outermost electrode tabs 15a are pushed toward the electrode assembly 10. Accordingly, the plurality of electrode tabs 15 may be aligned while being pushed toward the electrode assembly 10 between the pair of tab guides 30. Since the more outward the electrode tab 15 is disposed, the more pushed the electrode tab 15 is, a stepped portion may occur between outer ends of the plurality of electrode tabs 15.

Then, as illustrated in FIG. 5, the pair of tab guides 30 may approach each other and completely fix the plurality of electrode tabs 15, and the pair of aligning rollers 40 may move so that the pair of aligning rollers 40 are spaced apart from the outermost electrode tabs 15a, respectively, and away from each other.

Thereafter, as illustrated in FIG. 6, the welding part 50 may weld the plurality of electrode tabs 15 to each other and form the welded portion 16.

As the welding part 50 welds the plurality of electrode tabs 15 to each other in a state in which the tab guides 30 fix the plurality of aligned electrode tabs 15, the electrode tab 15, particularly the outermost electrode tab 15a, may have an increased length L (see FIG. 8) from the electrode assembly 10 to the welded portion 16. That is, the length of the electrode tab 15, particularly of the outermost electrode tab 15a, may have a margin.

Accordingly, the electrode tab 15, particularly the outermost electrode tab 15a, may be prevented from being broken and disconnected by swelling of the electrode assembly 10, an external force applied to the electrode tab 15, or the like.

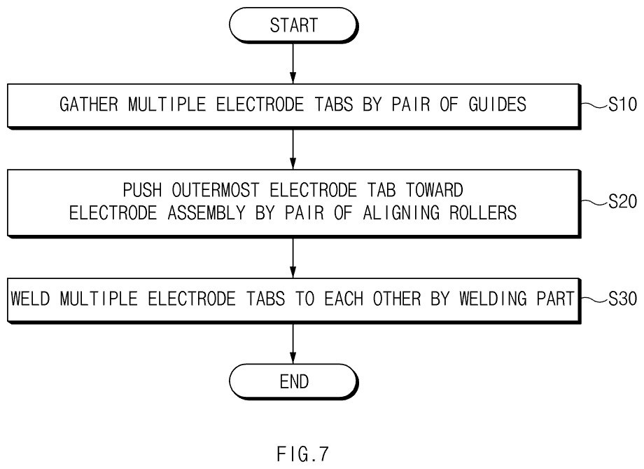

FIG. 7 is a flowchart of an electrode tab welding method according to another embodiment of the present invention.

Hereinafter, an electrode tab welding method using the electrode tab welding device described above will be described as another embodiment of the present invention.

The electrode tab welding method according to this embodiment of the present invention may weld a plurality of electrode tabs 15 of an electrode assembly 10 to each other. The electrode tab welding method may include allowing a pair of tab guides 30 to approach each other so as to gather the plurality of electrode tabs 15 (S10), allowing a pair of aligning rollers 40 to rotate in a state of pressing the plurality of electrode tabs 15 gathered by the pair of tab guides 30 so as to push the outermost electrode tab 15a toward the electrode assembly 10 (S20), and welding the plurality of electrode tabs 15, which are aligned by the pair of aligning rollers 40, to each other by a welding part 50 (S30).

In the gathering of the plurality of electrode tabs 15 (S10), the pair of tab guides 30 may approach each other and press the outermost electrode tab 15a so as to gather the plurality of electrode tabs 15.

In the pushing of the outermost electrode tab 15a toward the electrode assembly 10 (S20), the pair of aligning rollers 40 may approach each other so as to press the outermost electrode tab 15a, and may rotate so that the outermost electrode tab 15a is pushed toward the electrode assembly 10.

When the pair of aligning rollers 40 rotate, the pair of tab guides 30 may have a first gap g1 therebetween. The pair of tab guides 30 having the first gap g1 therebetween may relatively weakly press the plurality of electrode tabs 15 so that the plurality of electrode tabs 15 are not completely fixed.

Accordingly, the plurality of electrode tabs 15 may be aligned while being pushed toward the electrode assembly 10 between the pair of tab guides 30 through a frictional force therebetween. Since the more outward the electrode tab 15 is disposed, the more pushed the electrode tab 15 is, a stepped portion may occur between outer ends of the plurality of electrode tabs 15.

In the welding of the plurality of electrode tabs 15 to each other (S30), the welding part 50 may weld the plurality of electrode tabs 15 to each other and form the welded portion 16.

When the welding part 50 welds the plurality of electrode tabs 15 to each other, the pair of tab guides 30 may have a second gap g2 smaller than the first gap g1 therebetween. The pair of tab guides 30 having the second gap g2 therebetween may completely fix the plurality of electrode tabs 15. Accordingly, the plurality of electrode tabs 15 may be welded to each other by the welding part 50 in the state of being aligned with each other.

In addition, when the welding part 50 welds the plurality of electrode tabs 15 to each other, the pair of aligning rollers 40 may be spaced apart from the plurality of electrode tabs 15. For example, the electrode assembly 10 may be transferred from a first process position, at which the aligning rollers 40 are disposed, to a second process position at which the welding part 50 is disposed. Accordingly, the welding part 50 may weld the plurality of electrode tabs 15 to each other regardless of the position of the aligning rollers 40.

FIG. 8 is view illustrating an electrode assembly according to further another embodiment of the present invention.

Hereinafter, an electrode assembly 10 including a plurality of electrode tabs 15, which are welded by the electrode tab welding device or electrode tab welding method described above, will be described as further another embodiment of the present invention.

The electrode assembly 10 according to this embodiment may include a plurality of electrodes 11, which are stacked with each of a plurality of separators 13 therebetween, and the plurality of electrode tabs 15 which are connected to a plurality of electrodes 11, respectively, and welded to each other so as to form a welded portion 16. Both the outermost electrode tabs 15a of the plurality of electrode tabs 15 may be convexly bent outward.

At least some of the plurality of electrode tabs 15 may be provided to be convexly bent outward, and the more outward the electrode tab 15 is disposed, the more bent the electrode tab 15 may be. Thus, the outermost electrode tabs 15a may be bent most.

Each of the outermost electrode tabs 15a may have a longer length L from each of the electrodes 11 to the welded portion 16, compared to when the outermost electrode tab 15a is formed to be tight without bending. Accordingly, the outermost electrode tab 15a may be prevented from being broken and disconnected by swelling of the electrode assembly 10, an external force applied to the electrode tabs 15, or the like.

In more detail, the outermost electrode tab 15a may include a first section 151 extending from the electrode 11, and a second section 152 extending from the first section 151 and having a steeper slope than the first section 151. The outermost electrode tab 15a may further include a third section 153 extending from the second section 152 to the welded portion 16 and having a gentler slope than the second section 152. Such a configuration of the outermost electrode tab 15a may have characteristics obtained by welding the outermost electrode tab 15a in a state in which the outermost electrode tab 15a is pushed to an electrode assembly 10 side and aligned by an aligning roller 40.

The first section 151 may include a flat portion 151a, which is connected to the electrode 11 and provided to be flat, and a bending portion 151b which connects the flat portion 151a and the second section 152 to each other and is provided to be bent. That is, a point at which the outermost electrode tab 15a starts to bend may be spaced a predetermined gap from the electrode 11 with the flat portion 151a therebetween. Accordingly, there is an advantage that concentration of excessive stress is prevented from occurring in the outermost electrode tab 15a.

The outermost electrode tabs 15a may have an outer end that is stepped inward from outer ends of other electrode tabs 15. For example, the outer end of the outermost electrode tab 15a and an outer end of a center electrode tab may have a predetermined stepped portion S therebetween.

However, a cutting process, etc., for matching the outer ends of the plurality of electrode tabs 15 each other may be performed. In this case, the stepped portions may not be formed between the outer ends of the outermost electrode tab 15a and the outer ends of other electrode tabs 15.

The description of the present invention is just intended to be illustrative, and various changes and modifications can be made by those of ordinary skill in the art to which the present invention pertains, without departing from the spirit and scope of the present invention.

Therefore, the embodiments set forth herein are to describe the technical spirit of the present invention and not to limit. The scope of the technical spirit of the present invention is not limited by the embodiments.

Moreover, the protective scope of the present invention should be determined by reasonable interpretation of the appended claims and all technical concepts coming within the equivalency range of the present application should be interpreted to be in the scope of the right of the present application.

[Description of the Symbols]

| | |
|---|---|
| 10: Electrode assembly | 11: Electrode |
| 13: Separator | 15: Electrode tab |
| 15a: Outermost electrode tab | 151: First section |
| 151a: Flat portion | 151b: Bending portion |
| 152: Second section | 153: Third section |
| 16: welded Portion | 30: Tab guide |
| 40: Aligning roller | 50: Welding part |

1. An electrode tab welding device for welding a plurality of electrode tabs of an electrode assembly to each other, the electrode tab welding device comprising:
a pair of tab guides configured to gather the plurality of electrode tabs;
a pair of aligning rollers configured to rotate in a direction, in which an outermost electrode tab of the plurality of electrode tabs is pushed toward the electrode assembly, while pressing the plurality of electrode tabs gathered by the pair of tab guides; and
a welding part configured to weld the plurality of electrode tabs, which are aligned by the pair of aligning rollers, to each other.

2. The electrode tab welding device of claim 1, wherein a point at which the pair of aligning rollers press the plurality of electrode tabs is farther away from the electrode assembly than a point at which the pair of tab guides press the plurality of electrode tabs relative to the electrode assembly.

3. The electrode tab welding device of claim 1, wherein, when the pair of tab guides have a first gap therebetween, the pair of aligning rollers are configured to rotate in a state of pressing the plurality of electrode tabs, and
when the pair of tab guides have a second gap smaller than the first gap therebetween, the pair of aligning rollers are configured to be spaced apart from the plurality of electrode tabs.

4. The electrode tab welding device of claim 3, wherein, when the pair of tab guides have the second gap therebetween, the welding part is configured to weld the plurality of electrode tabs to each other.

5. The electrode tab welding device of claim 1, wherein each of the pair of aligning rollers comprises an elastomer material.

6. The electrode tab welding device of claim 1, wherein the pair of aligning rollers are disposed to face each other and configured to receive the plurality of electrode tabs therebetween in a height direction of the electrode assembly, and wherein the pair of aligning rollers are configured so that a distance therebetween is adjustable.

7. An electrode tab welding method that welds a plurality of electrode tabs of an electrode assembly to each other, the electrode tab welding method comprising:
allowing a pair of tab guides to approach each other so as to gather the plurality of electrode tabs;
allowing a pair of aligning rollers to rotate in a state of pressing the plurality of electrode tabs gathered by the pair of tab guides so as to push an outermost electrode tab of the plurality of electrode tabs toward the electrode assembly; and
welding the plurality of electrode tabs, which are aligned by the pair of aligning rollers, to each other by a welding part.

8. The electrode tab welding method of claim 7, wherein, when the pair of aligning rollers rotate, the pair of tab guides have a first gap therebetween, and
when the welding part welds the plurality of electrode tabs to each other, the pair of tab guides have a second gap smaller than the first gap therebetween.

9. The electrode tab welding method of claim 7, wherein, when the pair of aligning rollers rotate, a stepped portion occurs between outer ends of the plurality of electrode tabs.

10. The electrode tab welding method of claim 7, wherein, when the welding part welds the plurality of electrode tabs, the pair of aligning rollers are spaced apart from the plurality of electrode tabs.

11. An electrode assembly comprising:
a plurality of electrodes stacked with a separator therebetween; and
a plurality of electrode tabs which are connected to the plurality of electrodes, respectively, and welded to each other so as to form a welded portion,
wherein each outermost electrode tabs of the plurality of electrode tabs is convexly bent outward,
wherein the outermost electrode tabs comprises a first section extending from the electrode, and a second section extending from the first section and having a steeper slope than the first section,
wherein the first section comprises a flat portion connected to the electrode, and a bending portion which connects the flat portion and the second section to each other.

12. The electrode assembly of claim 11, wherein, in plurality of electrode tabs, electrode tabs disposed further outward are more bent than those electrode tabs disposed further inward.

13. The electrode assembly of claim 11, wherein the outermost electrode tabs have an outer end that is stepped inward from an outer end of another electrode tab.

14. The electrode assembly of claim 11, wherein the outermost electrode tabs further comprise a third section extending from the second section to the welded portion and having a less steep slope than the second section.
